(19) United States
(12) Patent Application Publication
(10) Pub. No.: US 2014/0147625 A1
(43) Pub. Date: May 29, 2014

(54) ADHESIVE DOUBLE-SIDED TAPE AND METHOD FOR MANUFACTURING SAME

(71) Applicant: HON HAI PRECISION INDUSTRY CO., LTD., New Taipei (TW)

(72) Inventor: DA-WEI LIN, New Taipei (TW)

(73) Assignee: HON HAI PRECISION INDUSTRY CO., LTD., New Taipei (TW)

(21) Appl. No.: 14/066,826

(22) Filed: Oct. 30, 2013

(30) Foreign Application Priority Data
Nov. 26, 2012 (TW) 101144204

(51) Int. Cl. C09J 7/02

(52) U.S. Cl. CPC C09J 7/026
USPC 428/140; 427/208

(57) ABSTRACT

An adhesive double-sided tape includes a base board, a first adhesive layer formed on one surface of the base board, and a second adhesive layer formed on another surface of the base board. The base board comprises a number of through holes. At least one of the first adhesive layer and the second adhesive layer is filled in the number of through holes to combine the first adhesive layer and the second adhesive layer together. A method for manufacturing the adhesive double-sided tape is also provided.

### BACKGROUND

1. Technical Field

The present disclosure relates to an adhesive double-sided tape and a method for manufacturing the same.

2. Description of Related Art

Adhesive double-sided tapes include a base board and two adhesive layers formed on two opposite surfaces of the base board. In use, the adhesive double-sided tape is sandwiched between two objects to adhere the two objects together. However, the base board is usually made of PET (polyethylene terephthalate), which has a high strength. Because the adhesive layers do not penetrate into the base board, when a great tension is exerted on the coupled objects, the adhesive layers are easily detached from the base board.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a cross-sectional view of an adhesive double-sided tape, according to one embodiment of the present disclosure.

FIG. 2 is a flowchart of a method for manufacturing the adhesive double-sided tape of FIG. 1, according to one embodiment of the present disclosure.

### DETAILED DESCRIPTION

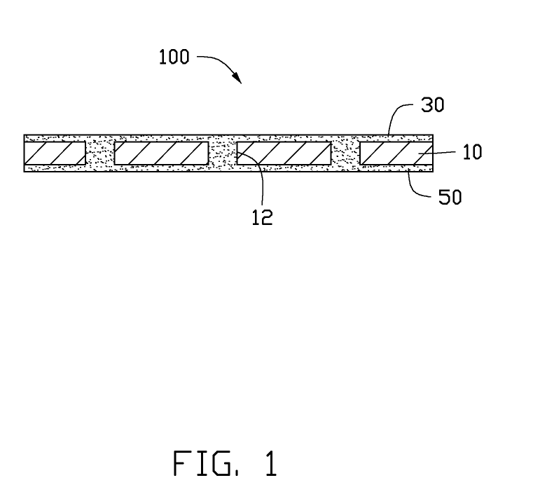

FIG. 1 shows an adhesive double-sided tape 100. The adhesive double-sided tape 100 includes a base board 10, a first adhesive layer 30, and a second adhesive layer 50. The base board 10 defines a plurality of through holes 12. The first adhesive layer 30 and the second adhesive layer 50 are formed on two opposite surfaces of the base board 10, respectively, and at least one of the first adhesive layer 30 and the second adhesive layer 50 is filled in the through holes 12 to combine the first adhesive layer 30 and the second adhesive layer 50 together.

The base board 10 is made of plastic, such as polyethylene terephthalate (PET), polyethylene (PE), Polyvinylchloride (PVC), polyimide (PI), or any combination of the above materials. A thickness of the base board 10 is about 12 micrometers (μm) to about 50 μm. A width of the through holes 12 is about 1 μm to about 100 μm, and a distance between adjacent through holes 12 is in a range from about 10 μm to about 100 μm. A cross-section of the through holes can be circular, oval, or any other shape. The distance between adjacent through holes 12 can be the same or different.

The first adhesive layer 30 and the second adhesive layer 50 can be made of the same materials or different materials. The first adhesive layer 30 and the second adhesive layer 50 comprise at least one compound selected from a group consisting of acrylic resin, silicone, rubber, and any variation of the above materials. A thickness of the adhesive layer 30 and the second adhesive layer 50 is in a range from about 10 μm to about 100 μm.

In a first embodiment, the base board 10 of the adhesive double-sided tape 100 is made of PET. The thickness of the base board 10 is about 12 μm. The through hole 12 is a circular hole having a diameter of about 1 μm. The distances between adjacent through holes 12 are each about 10 μm. The first adhesive layer 30 and the second adhesive layer 50 are made of acrylic resin. The thickness of both the first adhesive layer 30 and the second adhesive layer 50 is about 10 μm.

In a second embodiment, the base board 10 of the adhesive double-sided tape 100 is made of PET. The thickness of the base board is about 50 μm. The through hole 12 is a circular hole having a diameter of about 100 μm. The distances between adjacent through holes 12 are each about 100 μm. The first adhesive layer 30 and the second adhesive layer 50 are made of acrylic resin. The thickness of both the first adhesive layer 30 and the second adhesive layer 50 is about 100 μm.

In a third embodiment, the base board 10 of the adhesive double-sided tape 100 is made of PET. The thickness of the base board is about 20 μm. The through hole 12 is a circular hole having a diameter of about 30 μm. The distances between adjacent through holes 12 are the same, that is about 20 μm. The first adhesive layer 30 and the second adhesive layer 50 are made of acrylic resin. The thickness of the first adhesive layer 30 and the second adhesive layer 50 are about 20 μm.

In a fourth embodiment, the base board 10 of the adhesive double-sided tape 100 is made of PET. The thickness of the base board is about 20 μm. The through hole 12 is a circular hole having a diameter of about 30 μm. The distances between adjacent through holes 12 are that same, that is about 40 μm. The first adhesive layer 30 and the second adhesive layer 50 are made of acrylic resin. The thickness of the first adhesive layer 30 and the second adhesive layer 50 are about 30 μm.

In a fifth embodiment, the base board 10 of the adhesive double-sided tape 100 is made of PE. The thickness of the base board is about 20 μm. Each of the through holes 12 is a square hole having a length of about 30 μm. The distances between adjacent through holes 12 are random, and the distances are between about 10 μm to about 100 μm. The first adhesive layer 30 and the second adhesive layer 50 are made of acrylic resin. The thickness of the first adhesive layer 30 and the second adhesive layer 50 are about 30 μm.

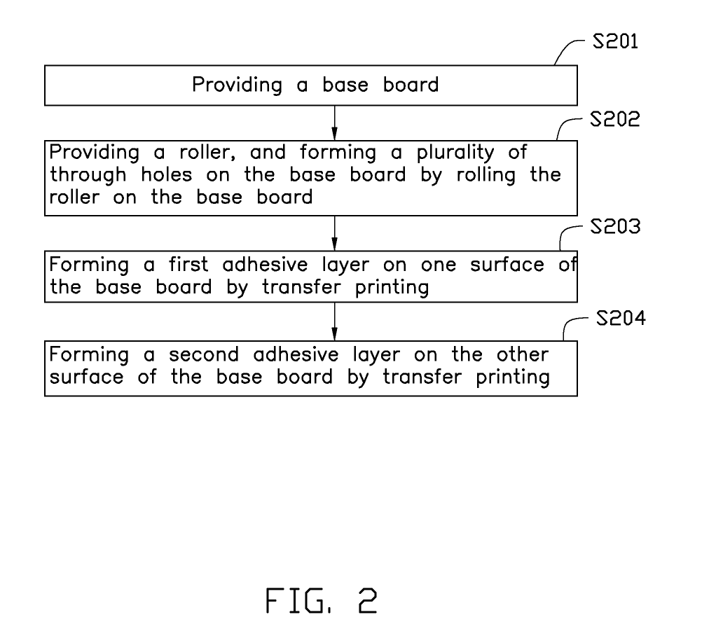

Referring to FIG. 2, an embodiment of a method for manufacturing the adhesive double-sided tape is disclosed as follows.

In step S201, a base board 10 is provided. In the illustrated embodiment, the base board 10 is made of PET, and the thickness of the base board 10 is about 12 μm.

In step S202, a roller is provided, and a plurality of through holes 12 is defined in the base board 10 by rolling the roller thereon. In the illustrated embodiment, the through holes 12 are circular holes having a diameter of about 1 μm. The distances between adjacent through holes are substantially equal and are about 10 μm.

In step S203, the first adhesive layer 30 is formed on one surface of the base board 10 by transfer printing. In the illustrated embodiment, the first adhesive layer 30 is made of acrylic resin, and the thickness of the first adhesive layer 30 is about 10 μm.

In step S204, the second adhesive layer 50 is formed on the other surface of the base board 10 by transfer printing. In the illustrated embodiment, the second adhesive layer 50 is made of acrylic resin, and the thickness of the second adhesive layer 30 is about 10 μm. At least one of the first adhesive layer 30 and the second adhesive layer 50 is filled in the through holes 12, so as to combine the first adhesive layer 30 and the second adhesive layer 50 together.

The first adhesive 30 and the second adhesive 50 combine with each other through the through holes 12. The first adhesive 30 and the second adhesive 50 act as a whole after curing, so as to improve the adhesive strength of the adhesive double-sided tape 100.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An adhesive double-sided tape, comprising:
a base board,
a first adhesive layer formed on one surface of the base board, and
a second adhesive layer formed on another surface of the base board;
wherein the base board defines a plurality of through holes, and at least one of the first adhesive layer and second adhesive layer is filled in the plurality of the through holes to combine the first adhesive layer and second adhesive layer together.

2. The adhesive double-sided tape as claimed in claim 1, wherein the base board comprises at least one compound selected from a group consisting of polyethylene terephthalate, polyethylene, polyvinylchlorid, polyimide or any combination of the above materials.

3. The adhesive double-sided tape as claimed in claim 1, wherein the first adhesive layer comprises at least one compound selected from a group consisting of acrylic resin, silicone, rubber, and any variation of the above materials.

4. The adhesive double-sided tape as claimed in claim 1, wherein the second adhesive layer comprises at least one compound selected from a group consisting of acrylic resin, silicone, rubber, and any variation of the above materials.

5. The adhesive double-sided tape as claimed in claim 1, wherein a thickness of the base board is in a range from about 12 μm to about 50 μm.

6. The adhesive double-sided tape as claimed in claim 1, wherein a thickness of each of the first adhesive layer and the second adhesive layer is in a range from about 10 μm to about 100 μm.

7. The adhesive double-sided tape as claimed in claim 1, wherein a diameter of the through hole is in a range from about 1 to about 100 μm, and a distance between two adjacent ones of the through holes is in a range from about 10 μm to about 100 μm.

8. A method of manufacturing a adhesive double-sided tape, comprising:
providing a base board;
providing a roller, and forming a plurality of through holes on the base board by rolling the roller on the base board;
forming a first adhesive layer on one surface of the base board by transfer printing;
forming a second adhesive layer on another surface of the base board by transfer printing, and at least one of the first adhesive layer and the second adhesive layer is filled in the plurality of the through holes to combine the first adhesive layer the second adhesive layer together.

9. The adhesive double-sided tape as claimed in claim 8, wherein the base board comprises at least one compound selected from a group consisting of polyethylene terephthalate, polyethylene, Polyvinylchlorid, polyimide or any combination of the above materials.

10. The adhesive double-sided tape as claimed in claim 8, wherein the first adhesive layer comprises at least one compound selected from a group consisting of acrylic resin, silicone, rubber, and any variation of the above materials.

11. The adhesive double-sided tape as claimed in claim 8, wherein the second adhesive layer comprises at least one compound selected from a group consisting of acrylic resin, silicone, rubber, and any variation of the above materials.

12. The adhesive double-sided tape as claimed in claim 8, wherein a thickness of the base board is in a range from about 12 μm to about 50 μm.

13. The adhesive double-sided tape as claimed in claim 8, wherein a thickness of each of the first adhesive layer and the second adhesive layer is in a range from about 10 μm to about 100 μm.

14. The adhesive double-sided tape as claimed in claim 8, wherein a diameter of the through hole is in a range from about 1 μm to about 100 μm, and a distance between two adjacent ones of the through holes is in a range from about 10 μm to about 100 μm.
